(19) United States
(12) Patent Application Publication
(10) Pub. No.: US 2003/0197789 A1
(43) Pub. Date: Oct. 23, 2003

(54) Multi-user control system for multi media sources

(75) Inventor: Douglas R. Coffland, Livermore, CA (US)

Correspondence Address: Eddie E. Scott, Assistant Laboratory Counsel, Lawrence Livermore National Laboratory, P.O. Box 808, L-703, Livermore, CA, 94551, US

(73) Assignee: The Regents of the University of California

(21) Appl. No.: 10/131,550

(22) Filed: Apr. 23, 2002

(51) Int. Cl. H04N 5/232

(52) U.S. Cl. 348/211.3; 709/220; 340/531

(57) ABSTRACT

A multi-user control system for multi-media sources. The system includes a module for connection initialization. A first software loop is performs main control functions including initializing a network, loading configurable features, and starting subsequent software control loops for single user control that execute in separate threads. Subsequent software loops perform single user control functions including executing associated features.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to multi-user control systems and more particularly to a multi-user control system for multi-media sources.

2. State of Technology

U.S. Pat. No. 6,271,752 to Christos I. Vaios issued Aug. 7, 2001 for an intelligent multi-access system provides the following information, “Over the past few decades computers and communications technology has evolved into a complex infrastructure where countless different systems, platforms, and other products are now interoperable. Only recently has the concept of open systems become a reality, permitting new developments in standard-based file transfer, electronic mail, and remote log in. Opportunistically, society is becoming increasingly dependent on many of the new technologies made available via phone communications, private computer networks, and the Internet.”

U.S. Pat. No. 5,771,383 to James Michael Magee, et al. issued Jun. 23, 1998 for a shared memory support method and apparatus for a microkernel data processing system provides the following information: “Operating systems can be classified as multi-user operating systems, multi-processor operating systems, multi-tasking operating systems, and real-time operating systems. A multiuser operating system allows two or more users to run programs at the same time. Some operating systems permit hundreds or even thousands of concurrent users. A multi-processing program allows a single user to run two or more programs at the same time. Each program being executed is called a process. Most multi-processing systems support more than one user. A multitasking system allows a single process to run more than one task. In common terminology, the terms multi-tasking and multi-processing are often used interchangeably even though they have slightly different meanings. Multitasking is the ability to execute more than one task at the same time, a task being a program. In multi-tasking, only one central processing unit is involved, but it switches from one program to another so quickly that it gives the appearance of executing all of the programs at the same time. There are two basic types of multi-tasking, preemptive and cooperative. In preemptive multi-tasking, the operating system parcels out CPU time slices to each program. In cooperative multi-tasking, each program can control the CPU for as long as it needs it. If a program is not using the CPU however, it can allow another program to use it temporarily. For example, the OS/2 (TM) and UNIX (TM) operating systems use preemptive multi-tasking, whereas the Multi-Finder (TM) operating system for Macintosh (TM) computers uses cooperative multi-tasking. Multi-processing refers to a computer system's ability to support more than one process or program at the same time. Multi-processing operating systems enable several programs to run concurrently. Multiprocessing systems are much more complicated than single-process systems because the operating system must allocate resources to competing processes in a reasonable manner. A real-time operating system responds to input instantaneously. General purpose operating systems such as DOS and UNIX are not real-time.”

U.S. Pat. No. 5,872,594 for a method for open loop camera control using a motion model to control camera movement to Paul A. Thompson, issued Feb. 16, 1999 provides the following information, “A typical surveillance application will have many more cameras than monitors, and fewer operators than monitors.—Controllable cameras in surveillance systems generally fall into three categories, 1) Inexpensive, manually operated, cameras only capable of movement responsive to manual pan, tilt, zoom, focus and iris commands from an operator, and which are the most common type; 2) More expensive, semi-automated cameras equipped with “preset” controls, which use servo mechanisms to position the camera to internally stored pan, tilt, zoom, focus, and iris positions. With this data, a plurality of “preset” views for each camera may be stored in the camera and used to direct the respective camera to a one, or a sequence, of these preset views responsive to operating a key on the keypad, and 3) very expensive cameras containing computers capable of complex operations such as communicating information to the camera control system.—Prior art of which Applicant is aware includes U.S. Pat. No. 4,992,866, issued to Morgan on Feb. 12, 1991. This reference discloses a camera control system requiring a number of computer controlled cameras, i.e. cameras that generate position information at the pan, tilt, zoom and focus motor drives and provide this information as feedback signals to operate the cameras in a closed loop configuration. These closed loop feedback signals are used in conjunction with a diagram that a user references to control movements of selected cameras. A conventional touch screen monitor and video switching matrix, under control of a microprocessor, provides a user with several options for selecting a particular camera, view, and monitor from a particular graphical representation. While this system provides a relatively simple way to use a touch screen to effect camera, view, and monitor selection, it is limited in that it requires an operator to select from a predefined list of fixed views, or “assets” located in the diagram, which are similar to presets. Further, there is no ability to select an arbitrary location to view, or to refer to entities to be viewed by name, as is found in a CADD drawing. Further yet, there is no disclosure in Morgan as to how the graphical representations relate to camera movement, or how these graphical representations are constructed. In addition, there is no capability for the system to monitor the camera video, or relate portions of the video to locations on the diagram. Another reference, U.S. Pat. No. 5,111,288, issued to Blackshear on May 5, 1992, discloses a feedback signal operated, closed loop camera system in conjunction with computer control used to store in memory one or more predetermined “presets,” or views of particular interest. Computer routines are provided for controlling camera movements from one preset to another preset. Additional computer routines are provided for immediately moving a camera to view a preset responsive to an alarm. Again, the system of Blackshear requires “smart” cameras with feedback position information of the pan and tilt mechanisms, with the attendant high cost of the cameras. Also, as each preset and sequence of presets must be manually entered into the computer, the system lacks the versatility needed for a large surveillance operation, such as found in a gambling casino.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a multi-user control system for multimedia sources. A first software loop is provided that performs main control functions including initializing a network, loading configurable features, and starting subsequent software control loops for single user control that execute in separate threads. Subsequent software loops are provided that perform single user control functions including executing associated features. A system for connection initialization is provided. In one embodiment the first software loop establishes connections and starts subsequent control loops to serve connections. In another embodiment the first software loop starts network services, calls the “StartCapture” feature to start capturing video frames, creates a MulticastSession object that will be used for secure transmission of multicast video, creates a data key in preparation for a request to receive video, establishes a multicast session for the transmission of secure multicast video, and enters a loop and waits for connection requests. In another embodiment the subsequent software loops establish secure communications with at least one remote host, accept command requests from the remote host, execute associated features, and create a new video data key when exiting if no other of the hosts are still connected.

Another embodiment of the invention provides a video surveillance system having a video camera/computer system that includes a multi-user control system for multi-media sources and a digital network. A first software loop is provided in the video camera/computer system that performs main control functions including initializing the digital network loading configurable features, and creating subsequent software control loops. Subsequent software loops are provided in the video camera/computer system that performs single user control functions including executing associated features. A system for connection initialization is provided. In one embodiment the first software loop establishes connections and spawns new threads to server connections. In another embodiment the first software loop starts network services, calls the “StartCapture” feature to start capturing video frames, creates a MulticastSession object that will be used for secure transmission of multicast video, creates a data key in preparation for a request to receive video, establishes a multicast session for the transmission of secure multicast video, and enters a loop and waits for connection requests.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates an embodiment of a multi-user control system for multimedia sources incorporating the present invention.

FIG. 2 shows the basic elements of another embodiment of a multi-user control system for multi-media sources incorporating the present invention.

FIG. 3 illustrates the process used to initialize the system, load configurable features, establish connections, and spawn new threads to serve connections to individual users

### DETAILED DESCRIPTION OF THE INVENTION

Referring now to the drawings, to the following detailed information, and to incorporated materials; a detailed description of the invention, including specific embodiments, is presented. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

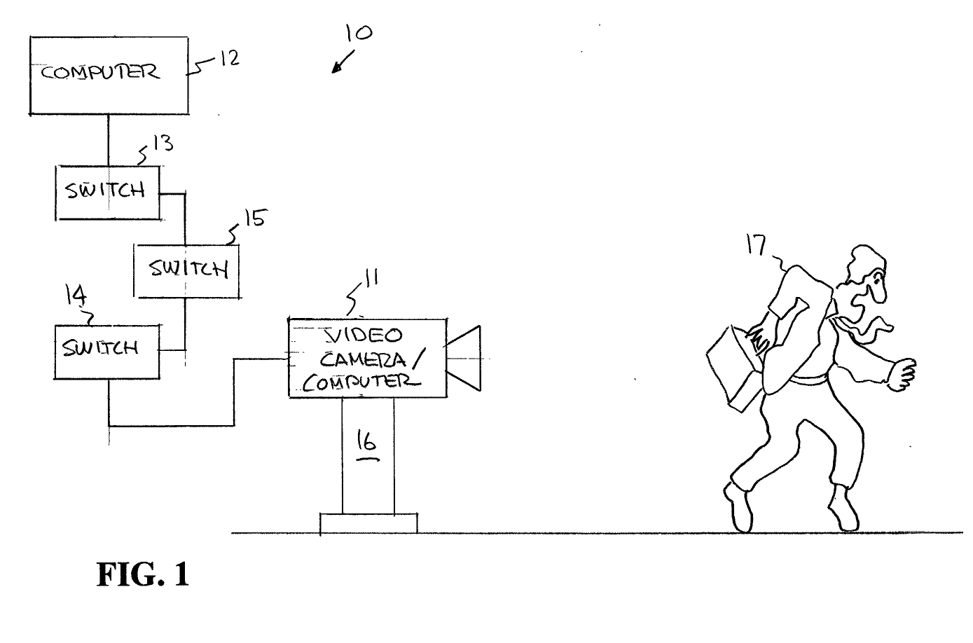

Referring now to FIG. 1, one embodiment of a multi-user control system for multi-media sources constructed in accordance with the present invention is illustrated. The multi-user control system for multi-media sources is incorporated in a security surveillance system. The system is designated generally by the reference numeral 10. The security surveillance system includes a video surveillance camera system connected to a digital network. The security surveillance system includes a digital camera/computer system 11 that forms part of the digital network. The digital camera/computer system 11 is show focused on a subject 17. The digital network includes or is connected to a computer/monitor 12. The computer 12 that is part of computer/monitor 12 and the computer that in is included in the digital camera/computer system 11 are understood to be a computer in the broad sense in that they are devices capable of performing a series of arithmetic or logical operations. These computers may be general-purpose computers or microprocessors that form a part of the overall system.

The security surveillance system provides simultaneous viewing and controlling of a single video resource or multiple video resources by multiple viewers. The security surveillance system provides for the sharing of resources on the digital network among multiple users. The surveillance system includes switches 13, 14, and 15 connected to additional video camera/computer systems, monitoring stations, viewers, status monitors, and controllers.

There is an increasing need for automated surveillance systems in private, government, airport, commercial, law enforcement, border, and military applications. In 1997, the Defense Advanced Research Projects Agency (DARPA) Information Systems Office began a three-year program to develop Video Surveillance and Monitoring (VSAM) technology. The objective of the VSAM project was to develop automated video understanding technology for use in future urban and battlefield surveillance applications. Technology advances developed under this project enable a single human operator to monitor activities over a broad area using a distributed network of active video sensors. The sensor platforms are mainly autonomous, notifying the operator only of salient information as it occurs, and engaging the operator minimally to alter platform operations.

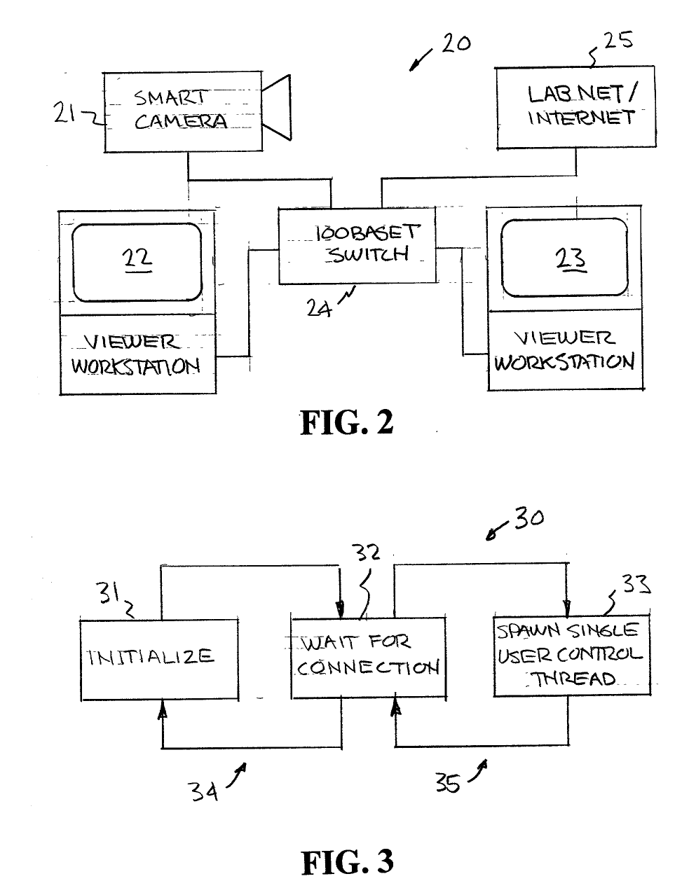

Referring now to FIG. 2 another embodiment of a multi-user control system for multi-media sources constructed in accordance with the present invention is illustrated. The multi-user control system for multi-media sources is incorporated in a security surveillance system. The system is designated generally by the reference numeral 20.

The surveillance system includes a video surveillance camera system connected to a digital network. The system includes a digital camera/computer system 21.

The digital network consists of a 100BaseT local area network switch 24. The switch allows video and control information to be passed between remote intelligent cameras and viewer workstations. The switch supports multiple simultaneous control and video streams to be passed over the network simultaneously. The digital network is connected to an internal or external network 25.

The multi-user control system for multi-media sources allows simultaneous viewing and controlling of a single video resource or multiple video resources by multiple viewers. Examples of use of simultaneous viewing and controlling of a single video resource by multiple viewers include transmission of live and recorded multimedia information. The multi-user control system for multi-media sources provides a software control system capable of simultaneously sending real-time video data to many remote receivers, while exchanging control and status information with any or all of the remote receivers.

The system 20 includes at least one video surveillance camera and at least one monitoring station. A first software loop is known as the Main Control Loop and is provided for initialization, for accepting connection requests, and for starting Single User Control Loops. Single User Control Loops are provided for accepting command requests from remote users and executing those commands. A system is provided for connection initialization. The Main Control loop initializes the network, loads configurable features, establishes connections, and spawns Single User Control loops for serving the connections. Single User Control loops execute single user control functions. In the multi-user control system for multi-media sources, the Main Control loop loads all configurable features, starts network services, calls the “StartCapture” feature to start capturing video frames, creates a MulticastSession object that will be used for secure transmission of multicast video, creates a data key in preparation for a request to receive video, establishes a multicast session for the transmission of secure multicast video, and enters a loop and waits for connection requests. The MulticastSession object that will be used for secure transmission of multicast video is created, but video transmission does not begin until a “Viewer” successfully connects and requests video transmission to begin. The data key is created in preparation for a request to receive video. Data keys are created before connection requests are made because is takes several hundred milliseconds to complete and would delay the connection time if the key were created after a connection request is received. After initialization is complete, the Main Control loop generates three beeps to notify humans that it has successfully booted, this is necessary since the system is “headless” and provides no other indication that it has booted successfully—this is useful for installation or maintenance personnel that may be physically working on the camera. After the three beeps, the Main Control loop waits for connection requests. For each connection request, a Single User Control loop is created. The Single User Control loop establishes secure communications with each remote host, accepts command requests from the remote host, executes the associated features, and creates a new video data key when exiting, if no other hosts are still connected. Connection initialization is performed by the Main Control loop and includes the following steps: a new secure socket that is to be used for the control session with the connecting host is created; a new thread is created to handle all further communications with the connecting host. After the connection initialization is complete, the Main Control loop continues to wait for the next connection request.

The system 20 provides a video surveillance system having a video camera/computer system that includes a multi-user control system for multimedia sources and a digital network. Main Control loop in the video camera/computer system is provided that performs main control functions including initializing the digital network and loading configurable features. Single User Control loops in the video camera/computer system are provided and perform single user control functions including executing features that are associated with commands received from remote “Viewers.” A system is provided for connection initialization. In one embodiment the Main Control loop establishes connections and spawns new threads to server connections. In another embodiment the Main Control loop starts network services, calls the “StartCapture” feature to start capturing video frames, creates a MulticastSession object that will be used for secure transmission of multicast video, creates a data key in preparation for a request to receive video, establishes a multicast session for the transmission of secure multicast video, and enters a loop and waits for connection requests. In another embodiment the Single User Control loop establishes secure communications with at least one remote host, accepts command requests from the remote host, executes associated features, and creates a new video data key when exiting if no other of the host is connected. In another embodiment the Single User Control loop establishes secure communications with each the remote host, accepts command requests from the remote host, executes the associated features, and creates a new video data key when exiting, if no other the host is still connected. In another embodiment the system for connection initialization performs the following steps: a new secure socket that is to be used for the control session with a connecting host is created; a new thread is created to handle all further communications with the connecting host; continue to wait for another connection request.

Referring now to FIG. 3, another embodiment of a multi-user control system for multi-media sources constructed in accordance with the present invention is illustrated. The multi-user control system for multi-media sources utilizes a process to initialize the monitoring system, load configurable features, establish connections, and spawn new threads to serve connections to individual users is illustrated. The system and process is generally designated by the reference numeral 30. The system 30 includes a software control system that executes on a multimedia source computer and is capable of simultaneously sending real time video data to many remote receivers, while exchanging control and status information with any or all of the remote receivers.

The multi-user control system for multi-media sources executes on a multimedia computer and includes two software loops 34 and 35. The Main Control loop 34 is responsible for system initialization, initial configuration, accepting new connections, and spawning independent threads of execution to serve each communications connection. A single user control loop 35 executes in each thread spawned by the main control loop 34. As such, a multithreading, multitasking operating system is required. The process 30 simultaneously provides shared access to the live multimedia stream to all remote hosts that are connected, and provides independent communications channels between the local system and each remote host for control and status information. The process 30 shown in FIG. 3 illustrates the steps initialize 31, wait for connection 32, and spawn single user control thread 33. The functions of the Main Control loop 34, the single user control loop 35, and connection initialization are described below.

Main Control Loop—The purpose of the main control loop 34 is to initialize the system, load configurable features, establish connections, and spawn new threads to serve connections to individual users. This process is depicted in FIG. 3. The main control loop 34 performs the following steps: 1) loads all configurable features; 2) starts winsock network services; 3) calls the “StartCapture” feature to start capturing video frames; (4) creates a MulticastSession object that will be used for secure transmission of multicast video (video transmission is not started, the object is just created); (5) creates a data key in preparation for a request to receive video. The data key is created before a request is made because is takes several hundred milliseconds to complete and would delay the connection time if the key were created after a connection request is received. (6) establishes a multicast session for the transmission of secure multicast video. (Generates three beeps to notify humans that it has successfully booted. This is necessary since the system is “headless” and provides no other indication that it has booted successfully. This is useful for installation or maintenance personnel that may be physically working on the camera); and (7) enters a loop and waits for connection requests.

Connection Initialization—When a connection request is received the following steps are performed: 1) a new secure socket that is to be used for the control session with the connecting host is created; 2) a new thread is created to handle all further communications with the connecting host; and 3) wait for the next connection request.

Single User Control Loop—The single user control loop 35 executes in the SingleUserControl function. The SingleUserControl function executes in a separate thread for each connection. The purposes of the single user control loop 35 are: 1) establish secure communications with each remote host; 2) accept command requests from the remote host, and execute the associated features; and 3) create a new video data key when exiting, if no other hosts are still connected.

The multi-user control system for multi-media sources method includes using a first software loop for initialization, using a multiple subsequent loops for execution; and using a system for connection initialization. The first software loop initializes the network, loads configurable features, establishes connections, and spawns new threads to server connections. The subsequent loops execute single user control functions. The first software loop loads all configurable features, starts winsock network services, calls the “StartCapture” feature to start capturing video frames, creates a MulticastSession object that will be used for secure transmission of multicast video, creates a data key in preparation for a request to receive video, establishes a multicast session for the transmission of secure multicast video, and enters a loop and waits for connection requests. The MulticastSession object that will be used for secure transmission of multicast video insures the video transmission is not started, the object is just created. The data key in preparation for a request to receive video insures the data key is created before a request is made because is takes several hundred milliseconds to complete and would delay the connection time if the key were created after a connection request is received. The multicast session for the transmission of secure multicast video generates three beeps to notify humans that it has successfully booted, this is necessary since the system is “headless” and provides no other indication that it has booted successfully—this is useful for installation or maintenance personnel that may be physically working on the camera.

The subsequent single user control loops establish secure communications with each remote host, accept command requests from the remote host, execute the associated features, and create a new video data key when exiting, if no other hosts are still connected. The means for connection initialization performs the following steps: a new secure socket that is to be used for the control session with the connecting host is created, a new thread is created to handle all further communications with the connecting host, and wait for the next connection request.

The multi-user control system for multi-media sources method includes a software control system capable of simultaneously sending real time video data to many remote receivers, while exchanging control and status information with any or all of the remote receivers. A connection mechanism is provided for connecting to remote viewers, status monitors, and controllers. The system and process 30 provides transmission of live and recorded multimedia information across digital networks. The system and process 30 automatically loads the feature configuration describing all flexible features that are available on the network. The system and process 30 captures messages from the remote network users and passes the messages to the feature modules for execution. The system and process 30 sends results from feature execution to the remote users. The system and process 30 provides a central logging capability that can also be displayed to users at remote systems. The system and process 30 provides a system for exchanging files with remote controllers. The system and process 30 provides for remote software updates.

Referring now to FIGS. 1, 2, and 3, a video surveillance system is illustrated having a video camera/computer system including a multi-user control system for multi-media sources, a digital network, and at least one remote viewer workstation. A first software loop in the video camera/computer system performs main control functions including initializing the digital network and loading configurable features. Subsequent single user control loops in the video camera/computer system perform single user control functions including executing associated features. A system is provided for connection initialization. In one embodiment the first software loop establishes connections and spawns new threads to serve connections. In another embodiment the first software loop starts network services, calls the “StartCapture” feature to start the video camera/computer system capturing video frames, creates a MulticastSession object that will be used for secure transmission of multicast video to the remote viewer workstation, creates a data key in preparation for a request to receive video, establishes a multicast session for the transmission of secure multicast video to the remote viewer workstation, and enters a loop and waits for connection requests. In another embodiment the second software loop establishes secure communications with at least one remote host, accepts command requests from the remote host, executes associated features, and creates a new video data key when exiting if no other of the host is still connected. In another embodiment the single user control loops establish secure communications with each remote host, accept command requests from the remote host, execute the associated features, and create a new video data key when exiting, if no other the host is still connected. In another embodiment the system for connection initialization performs the following steps: a new secure socket that is to be used for the control session with a connecting host, a new thread is created to handle all further communications with the connecting host, and wait for another connection request.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The Invention Claimed Is:

1. A multi-user control system for multi-media sources, comprising the steps of:
providing a first software loop that performs main control functions including initializing a network, loading configurable features, and starting subsequent software control loops for single user control that execute in separate threads,
providing subsequent software loops that perform single user control functions including executing associated features, and
providing a system for connection initialization.

2. The multi-user control system for multi-media sources of claim 1, wherein said first software loop establishes additional connections and starts additional software control loops for single user control that execute in separate threads.

3. The multi-user control system for multi-media sources of claim 1, wherein said first software loop starts network services, calls a “StartCapture” feature to start capturing video frames, creates a MulticastSession object that will be used for secure transmission of multicast video, creates a data key in preparation for a request to receive video, establishes a multicast session for the transmission of secure multicast video, and enters a loop and waits for connection requests.

4. The multi-user control system for multi-media sources of claim 1, wherein said subsequent software loops establish secure communications with at least one remote host, accept command requests from said remote host, execute associated features, and create a new video data key when exiting if no other of said hosts are still connected.

5. The multi-user control system for multi-media sources of claim 4, wherein said subsequent software loops establish secure communications with each said remote host, accept command requests from each said remote host, execute said associated features, and create a new video data key when exiting if no other said host is still connected.

6. The multi-user control system for multi-media sources of claim 1, wherein said system for connection initialization performs the following steps: creates a new secure socket that is to be used for the control session with a connecting host, creates subsequent software control loops in separate threads for handling all further communications with said connecting host, and waits for another connection request.

7. A video surveillance system having a video camera/computer system that includes a multi-user control system for multi-media sources and a digital network, comprising the steps of:
providing a first software loop in said video camera/computer system that performs main control functions including initializing said digital network loading configurable features, and creating subsequent software control loops,
providing a subsequent software loops in said video camera/computer system that performs single user control functions including executing associated features, and
providing a system for connection initialization.

8. The video surveillance system having a video camera/computer system that includes a multi-user control system for multi-media sources and a digital network of claim 7, wherein said first software loop establishes connections and spawns new threads to server connections.

9. The video surveillance system having a video camera/computer system that includes a multi-user control system for multi-media sources and a digital network of claim 7, wherein said first software loop starts network services, calls the “StartCapture” feature to start capturing video frames, creates a MulticastSession object that will be used for secure transmission of multicast video, creates a data key in preparation for a request to receive video, establishes a multicast session for the transmission of secure multicast video, and enters a loop and waits for connection requests.

10. The video surveillance system having a video camera/computer system that includes a multi-user control system for multi-media sources and a digital network of claim 7, wherein said subsequent software loops establish secure communications with at least one remote host, accept command requests from said remote host, execute associated features, and create a new video data key when exiting if no other of said hosts are still connected.

11. The video surveillance system having a video camera/computer system that includes a multi-user control system for multi-media sources and a digital network of claim 10, wherein said subsequent software control loops establish secure communications with each said remote host, accept command requests from each said remote host, execute said associated features, and create a new video data key when exiting, if no other said host is still connected.

12. The video surveillance system having a video camera/computer system that includes a multi-user control system for multi-media sources and a digital network of claim 7, wherein said system for connection initialization performs the following steps: a new secure socket that is to be used for the control session with a connecting host is created, a new thread is created to handle all further communications with said connecting host, wait for another connection request, and create subsequent software control loops to serve new connection requests.

13. A video surveillance system having a video camera/computer system that includes a multi-user control system for multi-media sources, a digital network, and at least one remote viewer workstation, comprising:
first software loop means in said video camera/computer system for performing main control functions including initializing said digital network, loading configurable features, and starting subsequent software control loops for single user control that execute in separate threads,
subsequent software loop means in said video camera/computer system for performing single user control functions including executing associated features, and
means for connection initialization.

14. The video surveillance system having a video camera/computer system that includes a multi-user control system for multi-media sources, a digital network, and at least one remote viewer workstation of claim 13, wherein said first software loop means establishes additional connections and starts additional software control loops for single user control that execute in separate threads.

15. The video surveillance system having a video camera/computer system that includes a multi-user control system for multi-media sources, a digital network, and at least one remote viewer workstation of claim 14, wherein said first software loop means starts network services, calls a “StartCapture” feature to start said video camera/computer system capturing video frames, creates a MulticastSession object that will be used for secure transmission of multicast video to said remote viewer workstation, creates a data key in preparation for a request to receive video, establishes a multicast session for the transmission of secure multicast video to said remote viewer workstation, and enters a loop and waits for connection requests.

16. The video surveillance system having a video camera/computer system that includes a multi-user control system for multi-media sources, a digital network, and at least one remote viewer workstation of claim 13, wherein said subsequent software control loops establish secure communications with at least one remote host, accept command requests from said remote host, execute associated features, and create a new video data key when exiting if no other of said hosts are still connected.

17. The video surveillance system having a video camera/computer system that includes a multi-user control system for multi-media sources, a digital network, and at least one remote viewer workstation of claim 16, wherein said subsequent software control loops establish secure communications with each said remote host, accept command requests from each said remote host, execute said associated features, and create a new video data key when exiting if no other said host is still connected.

18. The video surveillance system having a video camera/computer system that includes a multi-user control system for multi-media sources, a digital network, and at least one remote viewer workstation of claim 13, wherein said means for connection initialization performs the following steps: a new secure socket that is to be used for the control session with a connecting host, a new thread is created to handle all further communications with said connecting host, and wait for another connection request.
